(19) United States
(12) Patent Application Publication
(10) Pub. No.: US 2016/0034532 A1
(43) Pub. Date: Feb. 4, 2016

(54) FLEXIBLE OPERATORS FOR SEARCH QUERIES

(71) Applicants: Dmytro Andriyovich Ivchenko, Mountain View, CA (US); Niranjan Balasubramanian, Mountain View, CA (US)

(72) Inventors: Dmytro Andriyovich Ivchenko, Mountain View, CA (US); Niranjan Balasubramanian, Mountain View, CA (US)

(21) Appl. No.: 14/584,813

(22) Filed: Dec. 29, 2014

Related U.S. Application Data
(60) Provisional application No. 62/031,767, filed on Jul. 31, 2014.

(51) Int. Cl. G06F 17/30

(52) U.S. Cl. CPC G06F 17/30448; G06F 17/30011; G06F 17/30336

(57) ABSTRACT

In some embodiments, a rewritten search query is received. The rewritten search query can comprise a first flexible operator being applied to a term, a first condition, a first satisfaction target indicating a minimum amount of search results for the first flexible operator that are to satisfy the first condition, a second condition, and a second satisfaction target indicating a minimum amount of search results for the first flexible operator that are to satisfy the second condition. Search results for the first flexible operator can be determined from a search index. A first set of documents from the search index can be determined to be part of the search results for the first flexible operator based on the first set of documents satisfying the first condition without requiring the first set of documents to satisfy the second condition until a skip number for the second condition has been reached.

### CROSS-REFERENCE TO RELATED APPLICATIONS

This application claims priority to U.S. Provisional Application No. 62/031,767, filed on Jul. 31, 2014, and entitled, “FLEXIBLE OPERATORS FOR SEARCH QUERIES,” which is hereby incorporated by reference in its entirety as if set forth herein.

### TECHNICAL FIELD

The present application relates generally to data processing systems and, in one specific example, to methods and systems of providing flexible operators for search queries.

### BACKGROUND

Current processing of search queries suffers from a lack of diversity in the resulting search results, as well as excessive computational expense.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a client-server system, in accordance with an example embodiment;

FIG. 2 is a block diagram showing the functional components of a social network service within a networked system, in accordance with an example embodiment;

FIG. 3 is a block diagram illustrating components of a search engine, in accordance with an example embodiment;

FIG. 4 is a diagram illustrating determining search results using a flexible operator, in accordance with an example embodiment;

FIG. 5 is a diagram illustrating determining search results using a flexible operator, in accordance with an example embodiment;

FIG. 6 is a diagram illustrating determining search results using nested flexible operators, in accordance with an example embodiment;

FIG. 7 is a flowchart illustrating a method, in accordance with another example embodiment;

FIG. 8 is a flowchart illustrating a method, in accordance with another example embodiment;

FIG. 9 is a flowchart illustrating a method, in accordance with another example embodiment;

FIG. 10 is a flowchart illustrating a method, in accordance with another example embodiment;

FIG. 11. is a block diagram illustrating a mobile device, in accordance with some example embodiments; and

FIG. 12 is a block diagram of an example computer system on which methodologies described herein may be executed, in accordance with an example embodiment.

### DETAILED DESCRIPTION

Example methods and systems of providing flexible operators for search queries are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure introduces the use of one or more flexible operators in determining search results for a search query. In some embodiments, a rewritten search query is received. The rewritten search query can comprise a first flexible operator being applied to a term, a first condition, a first satisfaction target indicating a minimum amount of search results for the first flexible operator that are to satisfy the first condition, a second condition, and a second satisfaction target indicating a minimum amount of search results for the first flexible operator that are to satisfy the second condition. Search results for the first flexible operator can be determined from a search index comprising a plurality of documents. The determining of the search results for the first flexible operator can comprise determining a first skip number for the first condition based on the first satisfaction target, and determining a second skip number for the second condition based on the second satisfaction target. During a search through the search index in descending order of static rank, a first set of documents from the search index can be determined to be part of the search results for the first flexible operator based on the first set of documents satisfying the first condition without requiring the first set of documents to satisfy the second condition until the second skip number has been reached by the determinations of the first set of documents as part of the search results. In response to the second skip number being reached, during the search through the index in descending order of static rank, a second set of documents from the search index can be determined to be part of the search results for the first flexible operator based on the second set of documents satisfying the second condition.

In some embodiments, an initial search query comprising the term can be received, and the rewritten search query can be generated based on the term. In some embodiments, the generation of the rewritten search query can be further based on metadata corresponding to at least one member of a social networking service.

In some embodiments, it can be determined that the second skip number has been reached by the determinations of the first set of documents as part of the search results for the first flexible operator. Determining that the second skip number has been reached can comprise decrementing the second skip number for each one of the first set of documents from the search index being determined to be part of the search results without the second condition being satisfied, and determining that the second skip number has been reached in response to the second skip number being decremented to zero.

In some embodiments, the rewritten search query can further comprise a second flexible operator being applied to a third condition, a third satisfaction target for the third condition, and the first flexible operator. The third satisfaction target can indicate a minimum amount of search results for the second flexible operator that are to satisfy the third condition. In some embodiments, a third skip number for the third condition can be determined based on the third satisfaction target. During the search through the search index in descending order of static rank, a first preliminary document for the first flexible operator can be determined from the search index based on the first preliminary document satisfying the first condition without requiring the first preliminary document to satisfy the second condition or the third condition. During the search through the search index in descending order of static rank, a second preliminary document for the second flexible operator can be determined from the search index based on the second preliminary document satisfying the second condition without requiring the second preliminary document to satisfy the first condition or the third condition. During the search through the search index in descending order of static rank, a third preliminary document for the second flexible operator can be determined from the search index based on the third preliminary document satisfying the third condition without requiring the third preliminary document to satisfy the first condition or the second condition. The third preliminary document can be selected to be included in search results for the rewritten search query. The first preliminary document and the second preliminary document can be selected to be excluded from the rewritten search query. The first skip number for the first condition and the second skip number for the second condition can be decremented based on the selection of the first preliminary document and the second preliminary document to be excluded from the rewritten search query.

In some embodiments, the rewritten search query can comprise a hierarchical operator tree having all search operators of the rewritten search query, the first flexible operator being at a topmost level of the hierarchical operator tree with no other search operators above it.

In some embodiments, the first condition can comprise the term being present in a specified field associated with a document being considered for determination as one of the search results. In some embodiments, the second condition can comprise a minimum degree of connection between a first member of a social networking service associated with a document being considered for determination as one of the search results and a second member of the social networking service.

In some embodiments, the search results for the first flexible operator can be caused to be presented to a user who submitted the initial search query.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

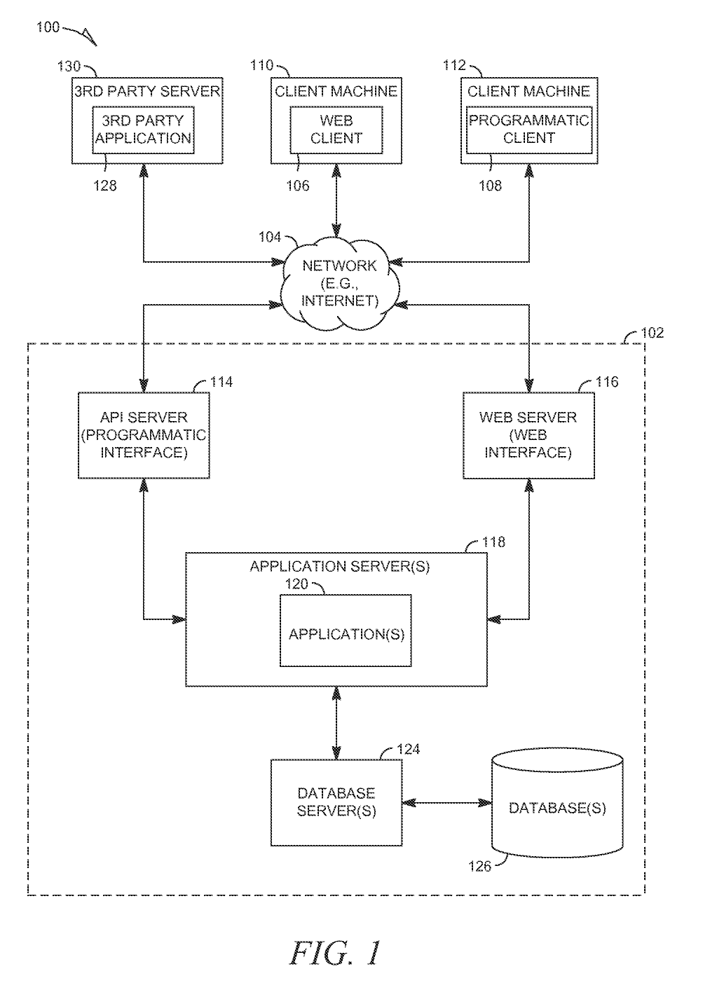

FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 12.0 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, the any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

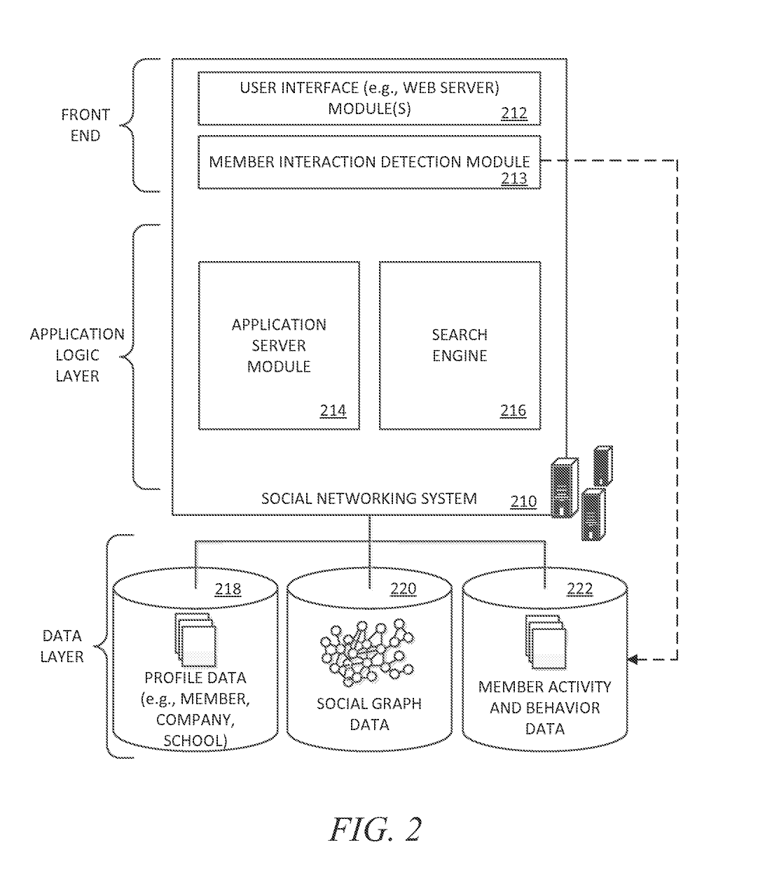

In some embodiments, the networked system 102 may comprise functional components of a social network service. FIG. 2 is a block diagram showing the functional components of a social networking service, including a data processing module referred to herein as a search engine 216, for use in generating and providing search results for a search query, consistent with some embodiments of the present disclosure. In some embodiments, the search engine 216 may reside on application server 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transport Protocol (HTTP) requests, or other web-based, application programming interface (API) requests. In addition, a member interaction and detection module 213 may be provided to detect various interactions that members have with different applications, services and content presented. As shown in FIG. 2, upon detecting a particular interaction, the detection module 213 logs the interaction, including the type of interaction and any meta-data relating to the interaction, in the activity and behavior database with reference number 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service.

As shown in FIG. 2, a data layer may include several databases, such as a database 218 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 218. Similarly, when a representative of an organization initially registers the organization with the social networking service, the representative may be prompted to provide certain information about the organization. This information may be stored, for example, in the database with reference number 218, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with reference number 220.

As members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 2 by the database with reference number 222. This logged activity information may then be used by the search engine 216 to determine search results for a search query.

In some embodiments, databases 218, 220, and 222 may be incorporated into database(s) 126 in FIG. 1. However, other configurations are also within the scope of the present disclosure.

Although not shown, with some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

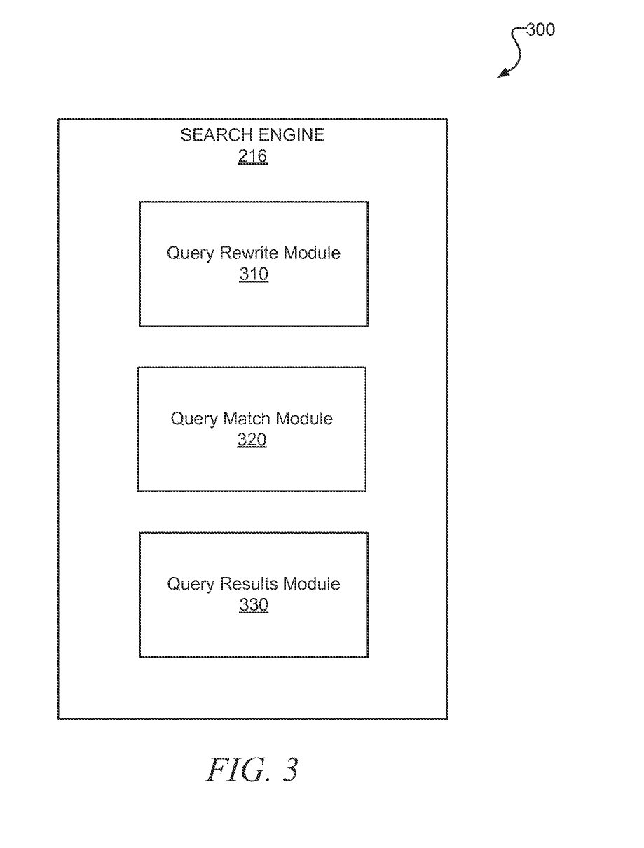

FIG. 3 is a block diagram illustrating components of the search engine 216, in accordance with an example embodiment. In some embodiments, the search engine 216 can comprise any combination of one or more of a query rewrite module 310, a query match module 320, and a query results module 330. These modules 310, 320, and 330 can reside on a machine having a memory and at least one processor (not shown). In some embodiments, these modules 310, 320, and 330 can be incorporated into the application server(s) 118 in FIG. 1. However, it is contemplated that other configurations are also within the scope of the present disclosure.

Query rewrite module 310 can be configured to receive an initial search query comprising a term from a user of the search engine 216. Query rewrite module 310 can also be configured to generate a rewritten search query based on the term. In some embodiments, the generation of the rewritten search query can be further based on metadata corresponding to at least one member of a social networking service. For example, the query rewrite module 310 can use metadata associated with the user that submitted the initial search query in generating the rewritten search query. Metadata of one or more other users can additionally or alternatively be used to generate the rewritten search query. Such metadata can include, but is not limited to, any profile data, social graph data, and/or member activity and behavior data, such as those stored in databases 218, 220, and 222 of FIG. 2. Other types of metadata are also within the scope of the present disclosure.

In some embodiments, query rewrite module 310 can rewrite the initial search query in a way that will produce amore diverse and more relevant set of search results than a search that is based merely on term matching and static rank. Query rewrite module 310 can generate a rewritten search query based on the initial search query. The rewritten search query can comprise one or more flexible operators. The flexible operator can comprise a type of search operator. A search operator is a language construct that can behave like a function for a search query and narrow the search results of the search query. Boolean operators, such as AND, OR, and NOT are examples of search operators. The flexible operator of the present disclosure (which can also be referred to herein as “FLEX”) enables the search engine 216 to provide diverse and relevant search results in an efficient way.

Each flexible operator of the rewritten query can have a corresponding condition to be satisfied by the search results. For example, if a user is using the search engine 216 on a social networking website to find people to recruit for a job opening, one condition can be that profiles that are returned to the user as part of the search results comprise profiles of users that have a specified job title. If a recruiter is searching for programmers for a programmer position, one condition can be that user profiles that are included in the search results have “programmer” for the metadata field of job title. Another condition can be that the users whose profiles are returned as part of the search results are connected to a specified user by at least a minimum specified degree of connections (e.g., user who are returned as part of the search results have a first degree or second degree connection with a specified user).

Each condition of the flexible operator can have a satisfaction target. The satisfaction target can comprise an indication of a minimum amount of search results for the corresponding flexible operator that are to satisfy the corresponding condition. This minimum amount can be a minimum percentage of the search results. For example, a flexible operator can be configured to cause 30% of the search results of the corresponding search query to comprise user profiles that have a first degree or second degree connection with a specified user.

In one example of a rewritten search query being generated from an initial search query, the initial search query can comprise the term “programmer” which has been entered into a search field by a user. Query rewrite module 320 can generate the following rewritten search query:
FLEX (Title: programmer 100% Connection: John Smith 30%)
   This rewritten search query can indicate a request that 100% of the user profiles returned as the corresponding search results of the flexible operator have “programmer” associated with their current job title, and that at least 30% of the user profiles returned as the corresponding search results of the flexible operator are connected to “John Smith” by one or two degrees of separation.

In some embodiments, the rewritten search query can comprise nested flexible operators. For example, query rewrite module 320 can generate the following rewritten search query:
FLEX₀ (FLEX₁ (Skill: Java 60% Connection: John Smith 60%) 100% Title: programmer 100%)
   The internal flexible operator (FLEX₁) can be configured to return results where 60% of the user profiles returned for the internal flexible operator (FLEX₁) have “Java” associated with their skill field, and that at least 60% of the user profiles returned for the internal flexible operator (FLEX₁) are connected to “John Smith” by one or two degrees of separation. The outer flexible operator (FLEX₀) can be configured to return results where 100% of the user profiles returned for the outer flexible operator (FLEX₀) satisfy the internal flexible operator (FLEX₁), and 100% of the user profiles returned for the outer flexible operator (FLEX₀) have “programmer” associated with their current job title. The results of the outer flexible operator (FLEX₀) can be provided as the search results of the initial search query, or provided to other processing components or operations before presentation to a user (e.g., the user who submitted the initial search query).

In some embodiments, the rewritten search query comprises a hierarchical operator tree having all search operators of the rewritten search query, whether they be flexible operators of standard search operators (e.g., boolean search operators). In some embodiments, the topmost level of the hierarchical operator tree comprises a flexible operator. In this respect the first operator in the rewritten search query can comprise a flexible operator and be absent any other type of search operator.

Other configurations of flexible operators are also within the scope of the present disclosure. Furthermore, although user profiles are used in the examples above, it is contemplated that any type of documents that are part of a search index are within the scope of the present disclosure.

Query match module 320 can be configured to receive the rewritten search query (e.g., from query rewrite module 310). Query match module 320 can determine search results for the flexible operator(s), and consequently the search query, from a search index comprising a plurality of documents based on the rewritten search query.

Unlike the processing of standard search operators, such as AND and OR, the features of the present disclosure can incorporate the use of skip numbers that enable the query match module 320 to select diverse search results, while at the same time maximizing the quality (e.g., static rank factors such as importance and/or popularity) of the search results. A corresponding skip number can be determined for each condition of the rewritten search query. Each skip number can be determined based on the corresponding satisfaction target of the corresponding condition. In some embodiments, the query match module 320 determines the total number of search results that it will return in response to the initial search query. For each condition in the rewritten search query, the query match module 320 can then determine the minimum number of the search results that should satisfy that condition based on the corresponding satisfaction target of the condition. For example, if the query match module 320 determines that the total number of search results for the initial search query is to be 100, and the satisfaction target for a condition is 30%, then the query match module 320 can determine that the minimum number of the search results that should satisfy that condition is 30 (100×30%=30). The skip number for that condition can then be determined by subtracting that determined minimum number from the total number of search results, which in this example would be 70 (100−30=70).

This skip number can be used by the query match module 320 as the number of documents that can be matched (e.g., selected to be part of the results for the corresponding flexible operator or search query) during a search through a search index in descending order of static rank without satisfying the corresponding condition. As the query match module 320 proceeds through the search index, from highest static rank down to lowest static rank, each time it selects (e.g., matches) a document for the search results that does not satisfy a condition of the rewritten search query, the corresponding skip number of that condition can be decremented, meaning that there is now one less selection that can be made that does not satisfy that condition. Once the number of documents that have been selected that do not satisfy the condition equals the original skip number (e.g., the skip number has been decremented to zero), the query match module 320 can then proceed to select only documents that satisfy that condition. By delaying the requirement that a condition be satisfied when selecting documents to be part of the search results for a search query (or a flexible operator that is part of the search query), the query match module 320 can maximize the quality of the search results, selecting a skip number amount of the highest ranked documents that satisfy a certain condition first before using another condition corresponding to the skip number to limit, narrow, or otherwise restrict the selection of documents as part of the search results.

Although the example satisfaction targets previously discussed herein comprise an indication of a minimum amount of search results for the corresponding flexible operator that are to satisfy the corresponding condition in the form of a minimum percentage of the search results, it is contemplated that, in other example embodiments, the indication of the minimum amount can comprise an absolute number. Furthermore, the use of a percentage to indicate whether a corresponding condition is required (e.g., 100%) or optional (e.g., any percentage from 1% to 99%) can be replaced with the use of a search operator indicating that the corresponding condition is required, such as ‘+’, and the use of a search operator indicating that the corresponding condition is optional ‘−’. In this respect, the query “FLEX java 100% engineer 30%” can instead be represented as “+java?engineer [30]”, indicating that at least 30 of the search results should satisfy the condition of including an “engineer”.

In some example embodiments, the FLEX query can be implemented as a special top-level aerator. The implementation can be dictated by the fact that, for the optional clauses, the requested amount of documents (or other search results) must be returned, if possible. In some example embodiments, the documents returned should also be of a highest static rank possible.

In some example embodiments, the initial query can be modified to make all optional clauses fully optional. The resulting rewritten query can be referred to as a query condition. As a result of the modification, a regular boolean query can be obtained. All optional clauses with a corresponding minimum number of requested documents greater than zero (e.g., [30] in the example above) can be collected. These clauses can also be referred to as unsatisfied clauses, and they can continue to be considered as part of the query until the corresponding minimum number of requested documents has been matched (e.g., until the minimum number of requested documents equals zero, with the number being decremented each time a corresponding match for the unsatisfied clause occurs. A skip number can be used to denote a number of documents that can be retrieved from the query condition without matching any of the unsatisfied clauses. In some example embodiments, the skip number can be set to the total number of search results to be returned (e.g., numToScore). Documents are then retrieved using the query condition until the skip number equals zero. On each final match, if at least one of the unsatisfied clauses is matched, the skip number is maintained at the same value. For each unsatisfied clause that is matched, the skip number is decremented by one. When the skip number equals zero, the unsatisfied clauses are then treated as required clauses. Retrieval then is performed similarly to a regular conjunction operator (e.g., using a leap frog algorithm). A minimum document ID can be calculated for all unsatisfied clauses and the query condition posting list can be advanced to this document ID. This procedure can be repeated until a match for both the query condition and at least one unsatisfied clause is found. Once all of the unsatisfied clauses are satisfied, the query execution can terminate.

Query results module 330 can be configured to cause any of the search results of the flexible operator(s) to be presented (e.g., displayed) to a user, such as to the user that submitted the initial search query. The query results module 330 can be configured to determine an order in which to present the search results, such as by scoring, ranking, and ordering the search results.

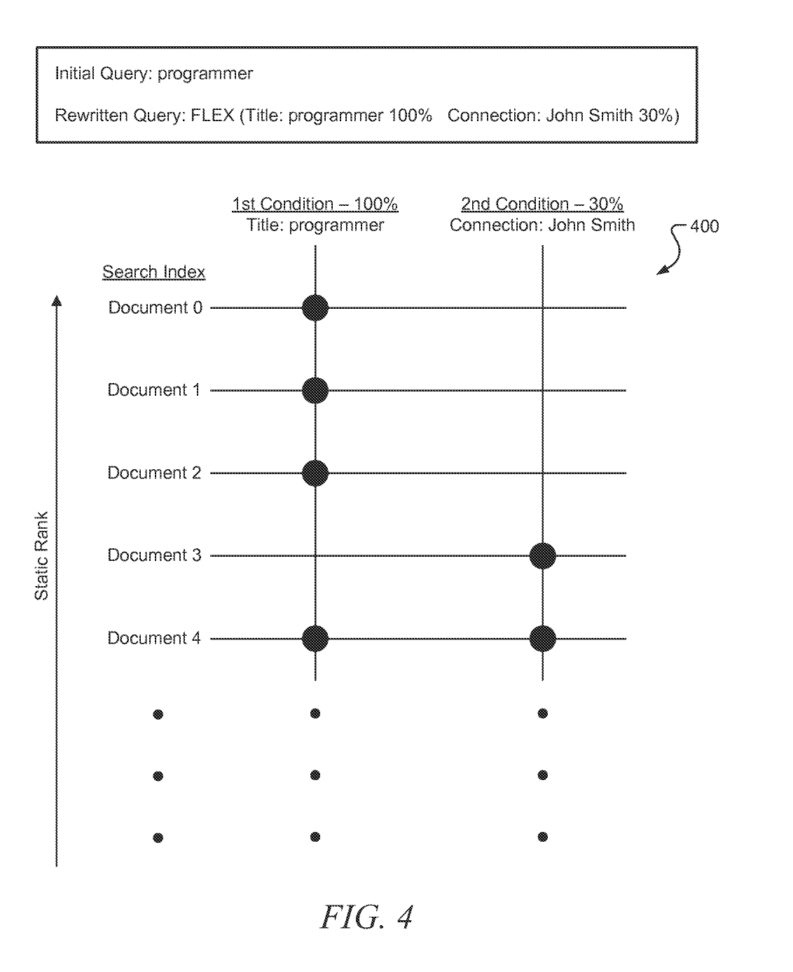

The features of query rewrite module 310, query match module 320, and query results module 330 will be discussed in additional detail below with respect to FIGS. 4-6.

FIG. 4 is a diagram illustrating determining search results using a flexible operator, in accordance with an example embodiment. In this example, an initial search query can comprise the term “programmer” which has been entered into a search field by a user. Query rewrite module 320 can generate the following rewritten search query:
FLEX (Title: programmer 100% Connection: John Smith 30%)
   This rewritten search query can indicate a request that 100% of the user profiles returned as the corresponding search results of the flexible operator have “programmer” associated with their current job title, and that at least 30% of the user profiles returned as the corresponding search results of the flexible operator are connected to “John Smith” by one or two degrees of separation.

A graph 400 is shown having a search index of documents (Document 0, Document 1, Document 2, . . . ) listed in descending order of static rank from the top down along the Y-axis, and the conditions of the rewritten search query (1st Condition and 2nd Condition) listed along the X-axis. Bold dots are included in the graph 400 to indicate what documents satisfy what conditions. In this example, it may be determined that the total number of search results for the initial search query is to be 100. As a result, the skip number for the first condition is 0 (100−100=0) and the skip number for the second condition is 70 (100−30=70).

The query match module 320 can traverse down through the search index, starting with the document (Document 0) with the highest static rank and select documents that satisfy the first condition regardless of whether or not they satisfy the second condition. In this example, once 70 documents that do not satisfy the second condition have been selected, the query match module 320 can go into panic mode and require that all subsequent selections of documents satisfy the second condition. In FIG. 4, Documents 0, 1, and 2 would be selected since they satisfy the first condition, regardless of their lack of satisfaction of the second condition. Since their selections do not satisfy the second condition, the skip number for the second condition gets decremented each time, going from 70 to 69 after the selection of Document 0, going from 69 to 68 after the selection of Document 1, and going from 68 to 67 after the selection of Document 2. Although Document 3 satisfies the second condition, it is not selected since it does not satisfy the first condition, which has a skip number of 0. Document 4 is selected as a search result since it satisfies the first condition. However, since it also satisfies the second condition, the skip number of the second condition is not decremented.

This selection process continues until the total number of search results is selected or until there are no more documents in the search index to select or evaluate for selection (e.g., the query match module 320 has reached the bottom of the search index). In response to the skip number for the second condition being decremented to zero, the query match module 320 requires the second condition be satisfied by any subsequent selections of documents.

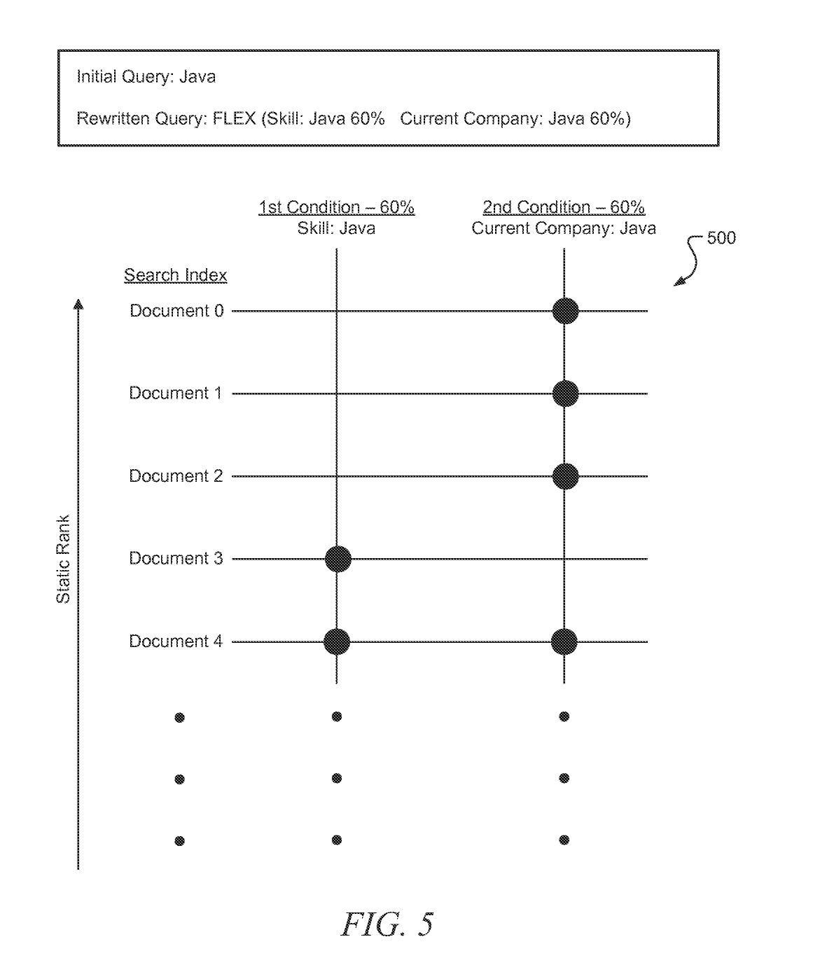

FIG. 5 is a diagram illustrating determining search results using a flexible operator, in accordance with an example embodiment. In this example, an initial search query can comprise the term “Java” which has been entered into a search field by a user. Query rewrite module 320 can generate the following rewritten search query:
FLEX (Skill: Java 60% Current Company: Java 60%)
   This rewritten search query can indicate a request that at least 60% of the user profiles returned as the corresponding search results of the flexible operator have “Java” associated with a skill field (e.g., the user corresponding to the profile lists “Java” as a skill on their profile, such as “Java programming”), and that at least 60% of the user profiles returned as the corresponding search results of the flexible operator have “Java” associated with a current company field (e.g., “Java” is in the name of the current company of the user corresponding to the profile).

A graph 500 is shown having a search index of documents (Document 0, Document 1, Document 2, . . . ) listed in descending order of static rank from the top down along the Y-axis, and the conditions of the rewritten search query (1st Condition and 2nd Condition) listed along the X-axis. Bold dots are included in the graph 500 to indicate what documents satisfy what conditions. In this example, it may be determined that the total number of search results for the initial search query is to be 100. As a result, the skip number for the first condition is 40 (100−60=40) and the skip number for the second condition is 40 (100−60=40).

The query match module 320 can traverse down through the search index, starting with the document (Document 0) with the highest static rank and select documents that satisfy the first condition regardless of whether or not they satisfy the second condition. In this example, once 40 documents that do not satisfy the first condition have been selected, the query match module 320 can require that all subsequent selections of documents satisfy the first condition. Similarly, once 40 documents that do not satisfy the second condition have been selected, the query match module 320 can require that all subsequent selections of documents satisfy the second condition. In FIG. 5, Documents 0, 1, and 2 would be selected since they satisfy the second condition, regardless of their lack of satisfaction of the first condition. Since their selections do not satisfy the first condition, the skip number for the first condition gets decremented each time, going from 40 to 39 after the selection of Document 0, going from 39 to 38 after the selection of Document 1, and going from 38 to 37 after the selection of Document 2. Since the selections of Documents 0, 1, and 2 satisfy the second condition, the skip number for the second condition does not get decremented. Document 3 is selected as a search result since it satisfies the first condition, regardless of its lack of satisfaction of the second condition. Since the selection of Document 3 does not satisfy the second condition, the skip number of the second condition is decremented from 40 to 39. However, the skip number of the first condition does not get decremented and remains at 37, since the first condition is satisfied by Document 3. Document 4 is selected, since it satisfies both the first condition and the second condition, although it only needs to satisfy one of the conditions to be selected. Since both conditions are satisfied by Document 4, the selection of Document 4 does not cause a decrement in the either of the corresponding skip numbers of the first condition and the second condition.

This selection process continues until the total number of search results is selected or until there are no more documents in the search index to select or evaluate for selection (e.g., the query match module 320 has reached the bottom of the search index). In response to the skip number for the first condition being decremented to zero, the query match module 320 requires that the first condition be satisfied by any subsequent selections of documents. Similarly, in response to the skip number for the second condition being decremented to zero, the query match module 320 requires that the second condition be satisfied by any subsequent selections of documents.

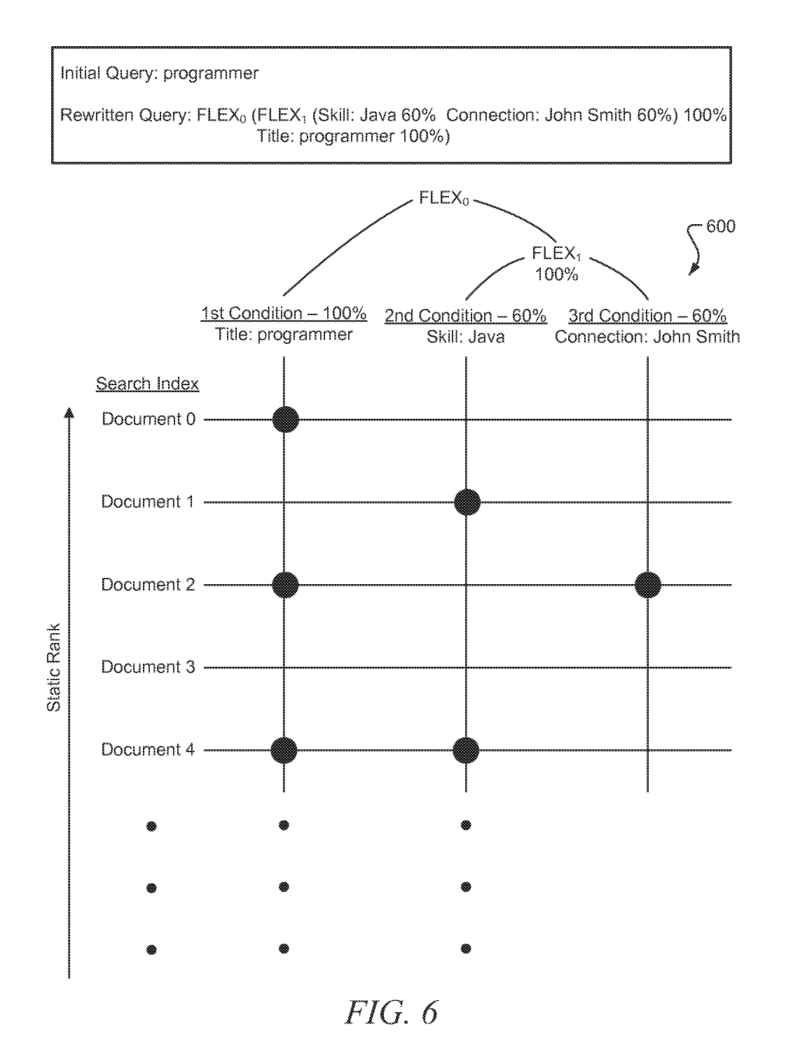

FIG. 6 is a diagram illustrating determining search results using nested flexible operators, in accordance with an example embodiment. In this example, an initial search query can comprise the term “programmer” which has been entered into a search field by a user. Query rewrite module 320 can generate the following rewritten search query:
FLEX₀ (FLEX₁ (Skill: Java 60% Connection: John Smith 60%) 100% Title: programmer 100%)
   The internal flexible operator (FLEX₁) can be configured to return results where 60% of the user profiles returned for the internal flexible operator (FLEX₁) have “Java” associated with their skill field, and that at least 60% of the user profiles returned for the internal flexible operator (FLEX₁) are connected to “John Smith” by one or two degrees of separation. The outer flexible operator (FLEX₀) can be configured to return results where 100% of the user profiles returned for the outer flexible operator (FLEX₀) satisfy the internal flexible operator (FLEX₁), and 100% of the user profiles returned for the outer flexible operator (FLEX₀)have “programmer” associated with their current job title. The results of the outer flexible operator (FLEX₀) can be provided as the search results of the initial search query, or provided to other processing components or operations before presentation to a user (e.g., the user who submitted the initial search query). Although only two flexible operators are shown in this example, it is contemplated the use of any number of nested flexible operators is within the scope of the present disclosure.

A graph 600 is shown having a search index of documents (Document 0, Document 1, Document 2, . . . ) listed in descending order of static rank from the top down along the Y-axis, and the conditions of the rewritten search query (1st Condition, 2nd Condition, and 3rd Condition) listed along the X-axis. Bold dots are included in the graph 600 to indicate what documents satisfy what conditions. In this example, it may be determined that the total number of search results for the initial search query is to be 100. As a result, the skip number for the first condition is 0 (100−100=0), the skip number for the second condition is 40 (100−60=40), and the skip number for the third condition is 40 (100−60=40). The internal flexible operator (FLEX₁) can also have a corresponding satisfaction target and skip number since it is nested within the external flexible operator (FLEX₀). In this example, the satisfaction target of the internal flexible operator (FLEX₁) is 100%, resulting in a corresponding skip number of 0 (100−100=0).

During the search through the search index in descending order of static rank, preliminary selections of documents can be made for the corresponding flexible operators using the techniques previously discussed. Since Document 0 satisfies the first condition (of FLEX₀), it is selected as a preliminary document for FLEX₀. Document 1 is selected as a preliminary document for FLEX₁, since Document 1 satisfies the second condition, regardless of the fact that it does not satisfy the third condition. Since FLEX₀ comprises a satisfaction target of 100% for FLEX₁, which is not satisfied by Document 0, Document 0 is not selected as a search result for the search query. Document 0 can be excluded from the search results for the search query. Since FLEX₀ comprises a satisfaction target of 100% for the first condition, which is not satisfied by Document 1, Document 1 is not selected as a search result for the search query. Document 1 can be excluded from the search results for the search query. As seen here, documents can be preliminarily selected for consideration to be included in the search results, but then subsequently excluded based on a higher level flexible operator.

Document 2 can be selected as a preliminary document for both FLEX₀ and FLEX₁, since it satisfies both the first condition and the third condition. Since Document 2 satisfies the highest level flexible operator in the hierarchical operator tree of the rewritten search query, it can be selected to be included in the search results for the search query. Since Document 2 does not satisfy the second condition, the skip number of the second condition can be decremented from 40 to 39 in response to the selection of Document 2. Since the first condition and the second condition are satisfied by Document 2, the corresponding skip numbers of the first condition and the second condition can remain the same (e.g., not be decremented).

This selection process continues until the total number of search results is selected or until there are no more documents in the search index to select or evaluate for selection (e.g., the query match module 320 has reached the bottom of the search index). In response to any of the skip numbers for conditions being zero or decremented to zero, the query match module 320 can require that the condition corresponding to that skip number be satisfied by any subsequent selections of documents.

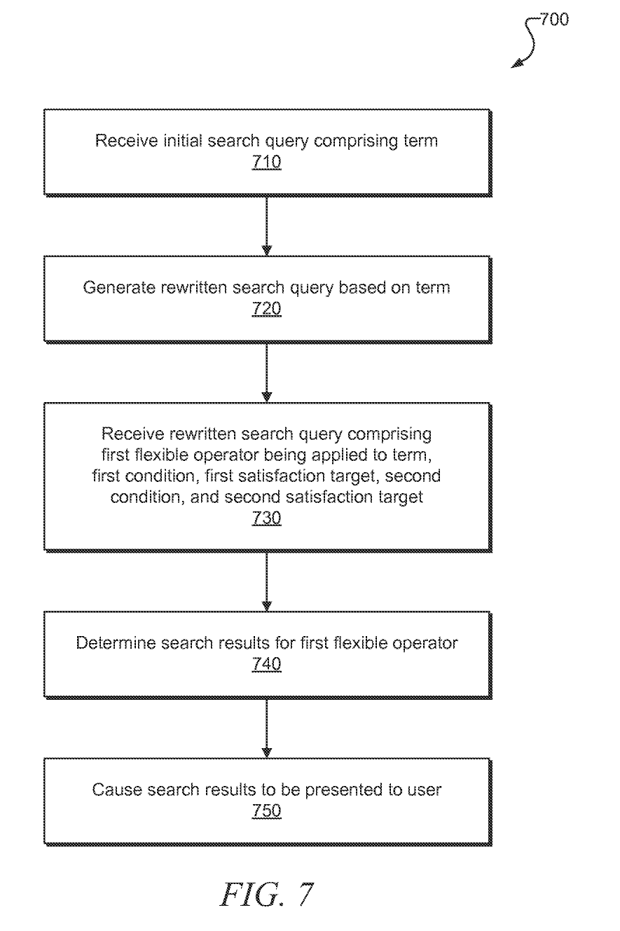

FIG. 7 is a flowchart illustrating a method 700, in accordance with another example embodiment. Method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the search engine 216 of FIGS. 2-3, or any combination of one or more of its modules, as described above.

At operation 710, an initial search query comprising a term can be received (e.g., by query rewrite module 310). At operation 720, a rewritten search query can be generated based on the term (e.g., by query rewrite module 310). In some embodiments, the generation of the rewritten search query can be further based on metadata corresponding to at least one member of a social networking service. At operation 730, the rewritten search query can be received (e.g., by query match module 320). The rewritten search query can comprise a first flexible operator being applied to a term, a first condition, a first satisfaction target indicating a minimum amount of search results for the first flexible operator that are to satisfy the first condition, a second condition, and a second satisfaction target indicating a minimum amount of search results fur the first flexible operator that are to satisfy the second condition. At operation 740, search results for the first flexible operator can be determined from a search index comprising a plurality of documents (e.g., by query match module 320). At operation 750, the search results for the first flexible operator can be caused to be present to a user (e.g., by query results module 330), such as a user that submitted the initial search query.

It is contemplated that any of the other features described within the present disclosure can be incorporated into method 700.

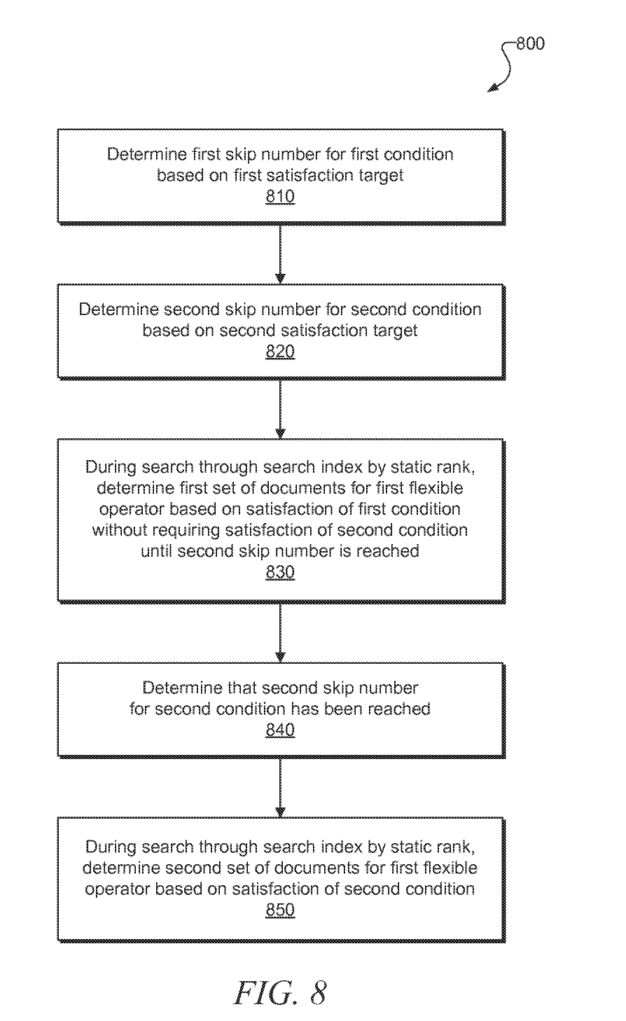

FIG. 8 is a flowchart illustrating a method 800 of determining search results for the first flexible operator, in accordance with another example embodiment. Method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the search engine 216 of FIGS. 2-3, or any combination of one or more of its modules, as described above.

At operation 810, a first skip number for the first condition can be determined based on the first satisfaction target. At operation 820, a second skip number for the second condition can be determined based on the second satisfaction target. At operation 830, during a search through the search index in descending order of static rank, a first set of documents from the search index can be determined to be part of the search results for the first flexible operator based on the first set of documents satisfying the first condition without requiring the first set of documents to satisfy the second condition until the second skip number has been reached by the determinations of the first set of documents as part of the search results. At operation 840, it can be determined that the second skip number has been reached by the determinations of the first set of documents as part of the search results. At operation 850, in response to the second skip number being reached, during the search through the index in descending order of static rank, a second set of documents from the search index can be determined to be part of the search results for the first flexible operator based on the second set of documents satisfying the second condition.

It is contemplated that any of the other features described within the present disclosure can be incorporated into method 800.

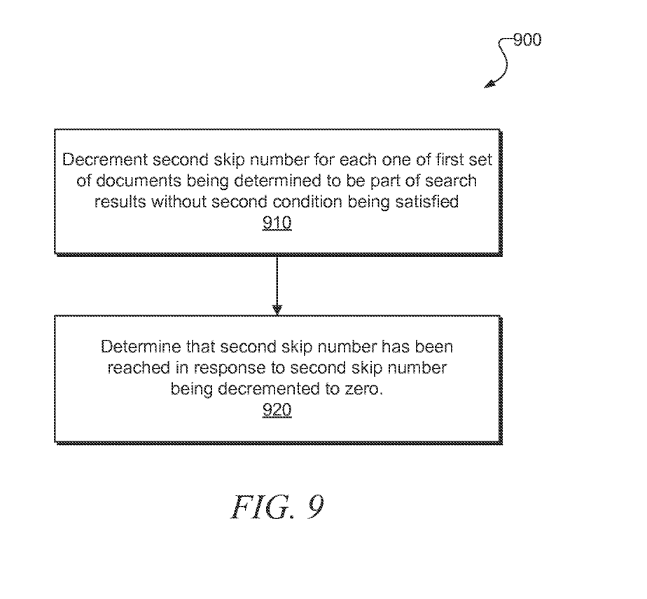

FIG. 9 is a flowchart illustrating a method 900 of determining that the second skip number has been reached by the determinations of the first set of documents as part of the search results for the first flexible operator, in accordance with another example embodiment. Method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the search engine 216 of FIGS. 2-3, or any combination of one or more of its modules, as described above.

At operation 910, the second skip number can be decremented for each one of the first set of documents from the search index being determined to be part of the search results without the second condition being satisfied. At operation 920, it can be determined that the second skip number has been reached in response to the second skip number being decremented to zero.

It is contemplated that any of the other features described within the present disclosure can be incorporated into method 900.

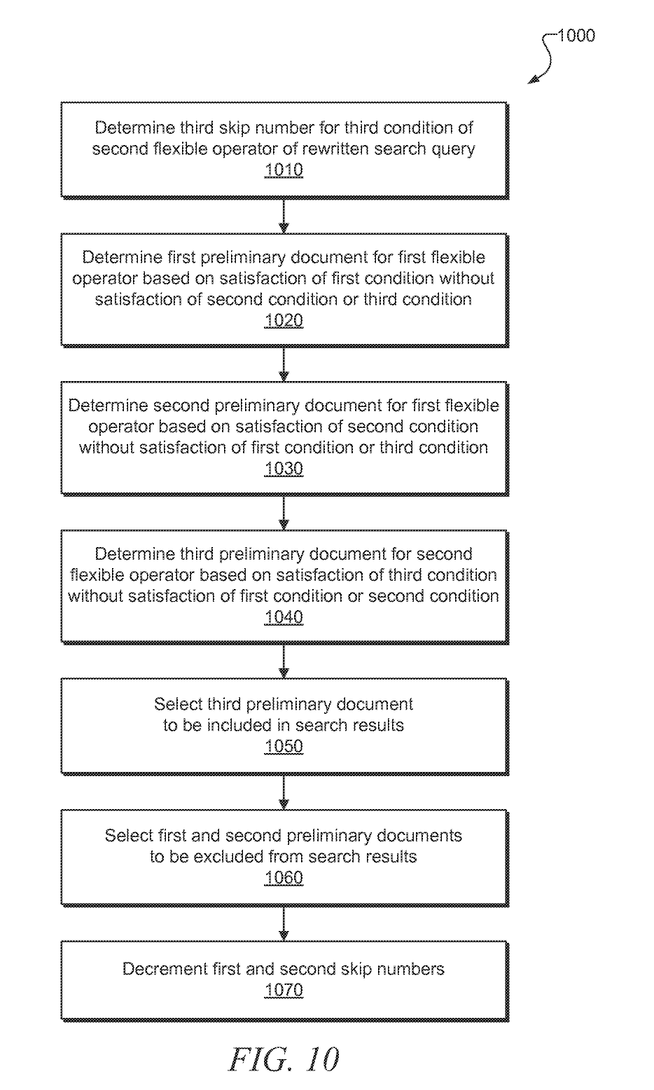

FIG. 10 is a flowchart illustrating a method 1000, in accordance with another example embodiment. Method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the search engine 216 of FIGS. 2-3, or any combination of one or more of its modules, as described above.

In some embodiments, the rewritten search query can further comprise a second flexible operator being applied to a third condition, a third satisfaction target for the third condition, and the first flexible operator. The third satisfaction target can indicate a minimum amount of search results for the second flexible operator that are to satisfy the third condition.

At operation 1010, a third skip number for the third condition can be determined based on the third satisfaction target. At operation 1020, during the search through the search index in descending order of static rank, a first preliminary document for the first flexible operator can be determined from the search index based on the first preliminary document satisfying the first condition without requiring the first preliminary document to satisfy the second condition or the third condition. At operation 1030, during the search through the search index in descending order of static rank, a second preliminary document for the second flexible operator can be determined from the search index based on the second preliminary document satisfying the second condition without requiring the second preliminary document to satisfy the first condition or the third condition. At operation 1040, during the search through the search index in descending order of static rank, a third preliminary document for the second flexible operator can be determined from the search index based on the third preliminary document satisfying the third condition without requiring the third preliminary document to satisfy the first condition or the second condition. At operation 1050, the third preliminary document can be selected to be included in search results for the rewritten search query. At operation 1060, the first preliminary document and the second preliminary document can be selected to be excluded from the rewritten search query. At operation 1070, the first skip number for the first condition and the second skip number for the second condition can be decremented based on the selection of the first preliminary document and the second preliminary document to be excluded from the rewritten search query.

It is contemplated that any of the other features described within the present disclosure can he incorporated into method 1000.

### EXAMPLE MOBILE DEVICE

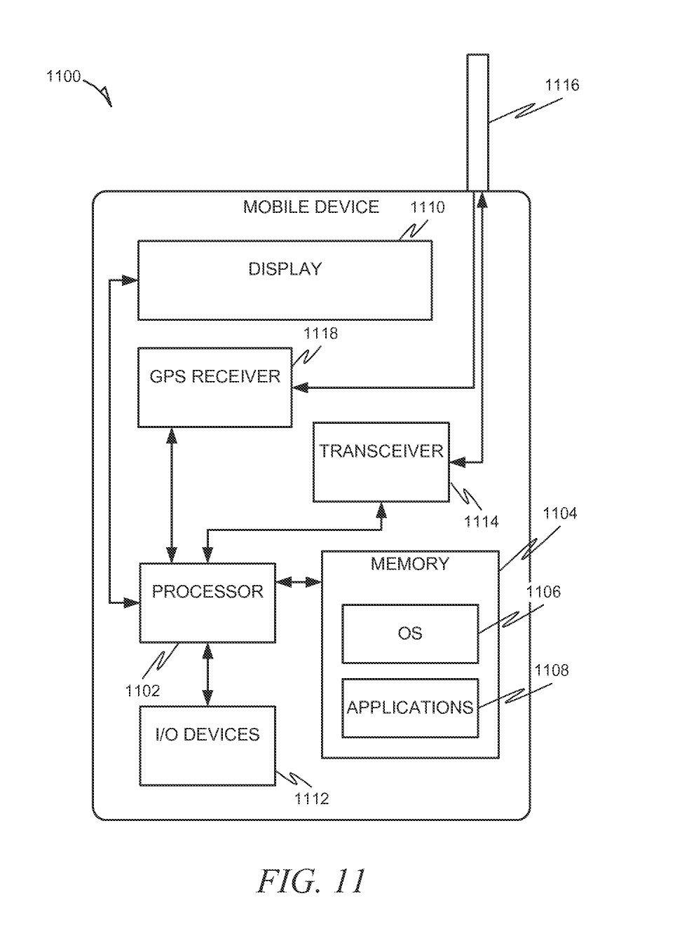

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor 1102. The memory 1104 can he adapted to store an operating system (OS) 1106, as well as application programs 1108, such as a mobile location enabled application that can provide LBSs to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### ELECTRONIC APPARATUS AND SYSTEM

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### EXAMPLE MACHINE ARCHITECTURE AND MACHINE-READABLE MEDIUM

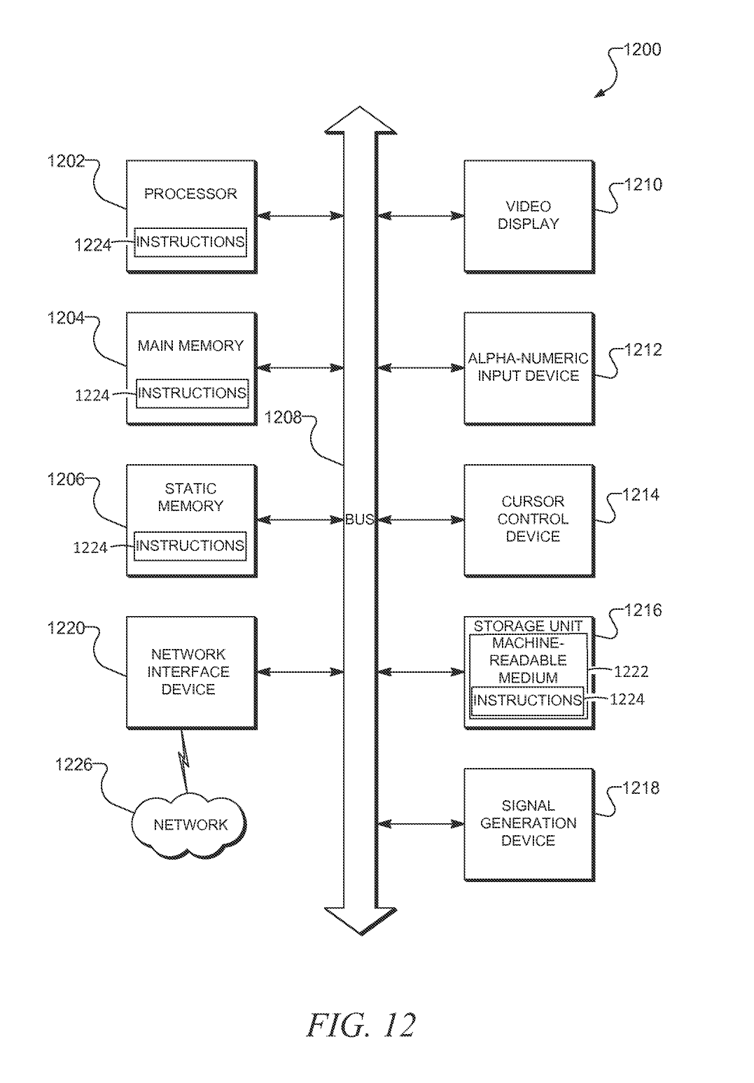

FIG. 12 is a block diagram of an example computer system 1200 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### MACHINE-READABLE MEDIUM

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### TRANSMISSION MEDIUM

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving a rewritten search query comprising a first flexible operator being applied to a term, a first condition, a first satisfaction target indicating a minimum amount of search results for the first flexible operator that are to satisfy the first condition, a second condition, and a second satisfaction target indicating a minimum amount of search results for the first flexible operator that are to satisfy the second condition; and
determining, by a machine having a memory and at least one processor, search results for the first flexible operator from a search index comprising a plurality of documents, the determining of the search results for the first flexible operator comprising:
determining a first skip number for the first condition based on the first satisfaction target;
determining a second skip number for the second condition based on the second satisfaction target;
during a search through the search index in descending order of static rank, determining a first set of documents from the search index to be part of the search results for the first flexible operator based on the first set of documents satisfying the first condition without requiring the first set of documents to satisfy the second condition until the second skip number has been reached by the determinations of the first set of documents as part of the search results; and
in response to the second skip number being reached, during the search through the index in descending order of static rank, determining a second set of documents from the search index to be part of the search results for the first flexible operator based on the second set of documents satisfying the second condition.

2. The method of claim 1, further comprising:
receiving an initial search query comprising the term; and
generating the rewritten search query based on the term.

3. The method of claim 2, wherein the generation of the rewritten search query is further based on metadata corresponding to at least one member of a social networking service.

4. The method of claim 1, further comprising determining that the second skip number has been reached by the determinations of the first set of documents as part of the search results for the first flexible operator, wherein determining that the second skip number has been reached comprises:
decrementing the second skip number for each one of the first set of documents from the search index being determined to be part of the search results without the second condition being satisfied; and
determining that the second skip number has been reached in response to the skip number for the second condition being decremented to zero.

5. The method of claim 1, wherein the rewritten search query further comprises a second flexible operator being applied to a third condition, a third satisfaction target for the third condition, and the first flexible operator, the third satisfaction target indicating a minimum amount of search results for the second flexible operator that are to satisfy the third condition.

6. The method of claim 5, further comprising:
determining a third skip number for the third condition based on the third satisfaction target;
during the search through the search index in descending order of static rank, determining a first preliminary document fur the first flexible operator from the search index based on the first preliminary document satisfying the first condition without requiring the first preliminary document to satisfy the second condition or the third condition;
during the search through the search index in descending order of static rank, determining a second preliminary document for the second flexible operator from the search index based on the second preliminary document satisfying the second condition without requiring the second preliminary document to satisfy the first condition or the third condition;
during the search through the search index in descending order of static rank, determining a third preliminary document for the second flexible operator from the search index based on the third preliminary document satisfying the third condition without requiring the third preliminary document to satisfy the first condition or the second condition;
selecting the third preliminary document to be included in search results for the rewritten search query;
selecting the first preliminary document and the second preliminary document to be excluded from the rewritten search query; and
decrementing the first skip number and the second skip number based on the selection of the first preliminary document and the second preliminary document to be excluded from the rewritten search query.

7. The method of claim 1, wherein the rewritten search query comprises a hierarchical operator tree having all search operators of the rewritten search query, the first flexible operator being at a topmost level of the hierarchical operator tree with no other search operators above it.

8. The method of claim 1, wherein the first condition comprises the term being present in a specified field associated with a document being considered for determination as one of the search results.

9. The method of claim 1, wherein the second condition comprises a minimum degree of connection between a first member of a social networking service associated with a document being considered for determination as one of the search results and a second member of the social networking service.

10. The method of claim 1, further comprising causing the search results for the first flexible operator to be presented to a user who submitted the initial search query.

11. A system comprising:
a memory;
at least one processor coupled to the memory; and
at least one module, executable by the at least one processor, configured to receive a rewritten search query comprising a first flexible operator being applied to a term, a first condition, a first satisfaction target indicating a minimum amount of search results for the first flexible operator that are to satisfy the first condition, a second condition, and a second satisfaction target indicating a minimum amount of search results for the first flexible operator that are to satisfy the second condition, and to determine search results for the first flexible operator from a search index comprising a plurality of documents, the determining of the search results for the first flexible operator comprising:
determining a first skip number for the first condition based on the first satisfaction target;
determining a second skip number for the second condition based on the second satisfaction target;
during a search through the search index in descending order of static rank, determining a first set of documents from the search index to be part of the search results for the first flexible operator based on the first set of documents satisfying the first condition without requiring the first set of documents to satisfy the second condition until the second skip number has been reached by the determinations of the first set of documents as part of the search results; and
in response to the second skip number being reached, during the search through the index in descending order of static rank, determining a second set of documents from the search index to be part of the search results for the first flexible operator based on the second set of documents satisfying the second condition.

12. The system of claim 11, wherein the at least one module is further configured to:
receive an initial search query comprising the term; and
generate the rewritten search query based on the term.

13. The system of claim 12, wherein the generation of the rewritten search query is further based on metadata corresponding to at least one member of a social networking service.

14. The system of claim 11, wherein the at least one module is further configured to determine that the second skip number has been reached by the determinations of the first set of documents as part of the search results for the first flexible operator, wherein determining that the second skip number has been reached comprises:
decrementing the second skip number for each one of the first set of documents from the search index being determined to be part of the search results without the second condition being satisfied; and
determining that the second skip number has been reached in response to the skip number for the second condition being decremented to zero.

15. The system of claim 11, wherein the rewritten search query further comprises a second flexible operator being applied to a third condition, a third satisfaction target for the third condition, and the first flexible operator, the third satisfaction target indicating a minimum amount of search results for the second flexible operator that are to satisfy the third condition.

16. The system of claim 15, wherein the at least one module is further configured to:
determine a skip number for the third condition based on the third satisfaction target;
during the search through the search index in descending order of static rank, determine a first preliminary document for the first flexible operator from the search index based on the first preliminary document satisfying the first condition without requiring the first preliminary document to satisfy the second condition or the third condition;
during the search through the search index in descending order of static rank, determine a second preliminary document for the second flexible operator from the search index based on the second preliminary document satisfying the second condition without requiring the second preliminary document to satisfy the first condition or the third condition;
during the search through the search index in descending order of static rank, determine a third preliminary document for the second flexible operator from the search index based on the third preliminary document satisfying the third condition without requiring the third preliminary document to satisfy the first condition or the second condition;
select the third preliminary document to be included in search results for the rewritten search query;
select the first preliminary document and the second preliminary document to be excluded from the rewritten search query; and
decrement the first skip number and the second skip number based on the selection of the first preliminary document and the second preliminary document to be excluded from the rewritten search query.

17. The system of claim 11, wherein the rewritten search query comprises a hierarchical operator tree having all search operators of the rewritten search query, the first flexible operator being at a topmost level of the hierarchical operator tree with no other search operators above it.

18. The system of claim 11, wherein the first condition comprises the term being present in a specified field associated with a document being considered for determination as one of the search results.

19. The system of claim 11, wherein the second condition comprises a minimum degree of connection between a first member of a social networking service associated with a document being considered for determination as one of the search results and a second member of the social networking service

20. A non-transitory machine-readable medium embodying a set of instructions that, when executed by a processor, cause the processor to perform operations, the operations comprising:
receiving a rewritten search query comprising a first flexible operator being applied to a term, a first condition, a first satisfaction target indicating a minimum amount of search results for the first flexible operator that are to satisfy the first condition, a second condition, and a second satisfaction target indicating a minimum amount of search results for the first flexible operator that are to satisfy the second condition; and
determining search results for the first flexible operator from a search index comprising a plurality of documents, the determining of the search results for the first flexible operator comprising:
determining a first skip number for the first condition based on the first satisfaction target;
determining a second skip number for the second condition based on the second satisfaction target;
during a search through the search index in descending order of static rank, determining a first set of documents from the search index to be part of the search results for the first flexible operator based on the first set of documents satisfying the first condition without requiring the first set of documents to satisfy the second condition until the second skip number has been reached by the determinations of the first set of documents as part of the search results; and
in response to the second skip number being reached, during the search through the index in descending order of static rank, determining a second set of documents from the search index to be part of the search results for the first flexible operator based on the second set of documents satisfying the second condition.
